(19) United States
(12) Patent Application Publication
(10) Pub. No.: US 2011/0147319 A1
(43) Pub. Date: Jun. 23, 2011

(54) USE, FOR FILTRATION, OF HOLLOW ELEMENTS FORMED FROM A HELICAL WINDING

(75) Inventors: Bernard Cottard, Saint Romain De Colbosc (FR); Matthew Allen, Orange, TX (US)

(73) Assignee: TOTAL RAFFINAGE MARKETING, Puteaux (FR)

(21) Appl. No.: 13/000,995

(22) PCT Filed: May 26, 2009
(86) PCT No.: PCT/FR09/50966

§ 371 Date: Mar. 2, 2011

(30) Foreign Application Priority Data
Jun. 23, 2008 (FR) 0803490

(51) Int. Cl. B01D 29/48; B01D 29/50

(52) U.S. Cl. 210/749; 210/767

(57) ABSTRACT

The invention relates to the use, for filtering one or more particle-laden fluids, of at least one hollow element obtained by the winding in touching and/or non-touching turns of a wire (F) of cross section (s), said hollow element having at least one closed end and a [free area (S_{free})/area occupied by the wire (Sₘ)] ratio of between 2 and 50%.

### TECHNICAL FIELD

The present invention relates to the field of the filtration of particle-laden fluids. Within the meaning of the present invention, the term “fluid” means liquids and gases and the term “particle” means solid and liquid particles. The invention applies to all industrial processes such as chemical, petrochemical, agrifoodstuffs or biological processes.

### PRIOR ART

In the field of industrial processes, there are in existence numerous elements, be they porous or otherwise, intended for improving the diffusion of fluids. Thus, in fixed bed catalytic reactors, solid inert beads, placed above the catalytic bed or on a distribution plate, can be used with a view to redistributing the charge stock in order to avoid creating preferred circuits, which are sources of hot spots and of coking in the catalytic bed. These inert beads are capable of withstanding the extreme temperature and pressure conditions of the industrial processes and are usually made of silica and of alumina. However, sometimes as the liquid fluid flows, the solid particles contained therein may build up in the free gap zones situated between the beads, it being possible for these beads to be arranged in several layers graded according to size. This retention of the particles on the inert bodies cannot be qualified as “filtration” within the meaning of the invention, inasmuch as it results from the way in which the beads are arranged within the reactor rather than the inherent geometry of the beads. Other elements based on ceramic, calcium carbonate, quartz or even glass may be used together with these inert beads and according to the application. These elements, which are either solid or hollow, may come with various geometries such as, for example, solid cylinders, four-spoke or seven-spoke wheels, star-like cylinders, spheres with one or five ducts through them, prisms, etc. Their dimensions may range from a few millimeters to almost 100 mm. Just as was the case with the inert beads, the impurities contained in the charge can accumulate in the free gaps or be held on the surface roughnesses of the elements. These elements can also be used in applications other than fixed bed catalytic reactors, for example in high-temperature filtration facilities aimed at separating solid and/or liquid particles from the hot gases. Even though they are sometimes qualified as “filtering” elements, these various elements are not filtering within the meaning of the invention because their retention capabilities are dependent on how the elements are arranged relative to one another rather than being dependent on their own inherent geometries. The retention of particles by these elements therefore remains low and uncertain.

In addition, the build-up of particles in the gaps between the elements may lead to clogging of the latter thus creating preferred circuits which are sources of hot spots.

For the purposes of extracting solids from liquids, patent GB 2 116 445 proposes the use of packing pieces of the Rashig rings, Pall rings type or components in the form of tiles with a total void fraction exceeding 50% and a minimum dimension of 5 mm. This filter medium is used in conjunction with a conventional granular medium of the bed of sand, gravel or graded anthracite type. However, it has become apparent that, as a result of their open geometry, the elements are unable systematically to retain the particles. Once again, the particles can build up only in the free gaps between the elements and/or in the roughnesses.

Faced with the disadvantages of the prior art, it would therefore seem to be essential to design elements that are specially designed and dedicated to filtering particle-laden fluids. Surprisingly, the Applicant Company has found that a hollow element, configured like a spring, has a true ability to retain the particles contained in a fluid while at the same time maintaining the circulation of said fluid throughout the entire space or within the device containing it. In this respect, the present invention intends to overcome the disadvantages of the prior art by proposing the use of hollow elements comprising contiguous turns and/or non-contiguous turns for filtering particle-laden fluids.

U.S. Pat. No. 3,584,685 describes a tubular filtration element supported by a support plate. This filtration element is formed of a helical wire fixed to rods attached to the plate at right angles to the latter and is therefore secured to the plate, its axis being perpendicular to the surface of the plate.

However, in that document, the filtration element is secured to the plate and at no time is any other use of this element, notably the “bulk” use thereof in a filtration bed, imagined.

### DESCRIPTION OF THE INVENTION

The invention relates to the use in a fixed bed catalytic reactor for filtering one or more particle-laden fluid(s) of at least one hollow element obtained by the winding into contiguous and/or non-contiguous turns of at least one wire of cross section (s), said hollow element comprising at least one closed end and having a ratio of free surface area (S_{free}) to surface area (S_{wire}) occupied by the wire that is comprised between 2 and 50%, preferably comprised between 5 and 30%, more preferably still comprised between 15 and 25%, in which use said at least one hollow element is positioned upstream of the fixed catalytic bed of the reactor.

What is meant by the surface area (S_{wire}) occupied by the wire is the surface area occupied by the wire when the hollow element is developed, over its entire periphery, onto a plane positioned at right angles to the axis of winding of its turns, the free surface area (S_{free}) then corresponding to the surface area not free, occupied by the wire in this projection. Put differently, the surface area (S_{wire}) occupied by the wire is the surface area of the wire projected onto a surface enveloping the outside of the hollow element concerned, this surface then being opened out and “flattened” onto a plane to make it possible to measure it, the free surface area (S_{free}) then corresponding to the area not occupied by the projection free, of the wire.

For preference, the hollow element is obtained by winding a single wire into contiguous and/or non-contiguous turns. Because the winding of a hollow element according to the invention can be likened to that of a spring, it is possible to give it any geometry, for example to make it cylindrical, spherical, barrel-shaped, amphora-shaped, conical, oblong, square, polygonal and any cross section, for example a round, square, rectangular, triangular, oval, etc. cross section. For preference, the filtering element is a cylinder or a sphere, it being possible for this sphere to be a perfect sphere or one that is slightly deformed depending on the pitch of the turns of the winding.

Whatever its geometry, the filtering element has two ends, which can be closed and/or open. For preference, the filtering element comprises one open end and one closed end. It may also have two closed ends, the wire then being wound in non-contiguous turns.

The closed end of the element may be obtained by winding a wire of cross section (s) in contiguous turns either by winding flat or with narrowing, preferably of the conical type. The element may also be closed off at one of its ends at least by any other capping element, be it flat or three-dimensional, of any appropriate geometry and material.

The filtering element is made of any material capable of withstanding the extreme pressure, temperature and corrosion conditions of industrial processes, such as metallic materials (steel, stainless steel, bronze, beryllium bronze, etc.), alloys (“Monel”, “Inconel”, etc.), ceramic, plastic (polypropylene, PVDF, C-PVC, PFA, ETFE, ECTFE, PTFE, etc.), composites, graphite, glass. For preference, the hollow element is made of stainless steel or steel.

Whatever its geometry, the filtering element may consist, over its entire height, of non-contiguous turns of constant or variable pitch or of contiguous turns or alternatively of a combination of contiguous turns and of non-contiguous turns. For preference, the filtering element comprises an open end followed by a fluid inlet zone Z1 consisting of non-contiguous turns of pitch P1, followed by a fluid filtration zone Z2 consisting of non-contiguous turns of pitch P2<P1 and which is extended by a closed end of the element. The open end, the inlet zone and the filtration zone may follow on directly from one another or alternatively may be separated from one another by at least one contiguous turn. For preference, the ratio P1/P2 of the pitches of the non-contiguous turns is such that P1/P2≦50, more preferably still, P1/P2≦15.

Although the dimensions can be chosen at will, according to the field of application, the filtering element is preferably designed to filter particles the size of which is comprised between 1 μm and 20 mm. It should be noted that, unless indicated otherwise, within the meaning of the present invention, the expression “comprised between a value X and a value Y” means a range in which the end points X and Y are included.

As explained before, the invention relates to the use for filtering of at least one hollow element obtained by a helical winding of a wire of cross section (s). Advantageously, filtration is performed using a filter bed comprising at least one layer of said elements.

Within one same layer of the filter bed, the hollow filtering elements are preferably identical to one another in terms of shape and dimensions. Said hollow filtering elements may be used alone or in combination with other elements of different shapes and/or dimensions and/or functions. Said elements combined with the filtering elements may be bits of packing and/or inert elements such as inert beads and/or porous ceramic elements and/or particles of catalyst.

When the filtration bed comprises several layers, these layers are preferably organized in a gradient graded on filtering element size and, more particularly, from the upstream end of the reactor downstream, on a decreasing gradient.

The use, for filtering, of the hollow elements may be applied to any industrial process in which it is necessary to purify a fluid charge.

Thus, these hollow elements may be used in a fixed bed catalytic reactor, particularly for hydrotreatment reactions, preferably in the field of refinery (for example in hydrodesulfuration reactors). They may also be used for treating waste water or agrifoodstuffs liquids.

### FIGURES

The figures which follow are entirely nonlimiting.

FIGS. 1 to 4 depict exemplary embodiments of filtering elements of the invention. Each element is depicted in side view and in plan view. The element depicted in FIG. 4 is also depicted in transverse cross section.

FIGS. 5 to 15 depict inert elements viewed from above and in longitudinal section. The dimensions of these elements, in millimeters, are marked in the figures.

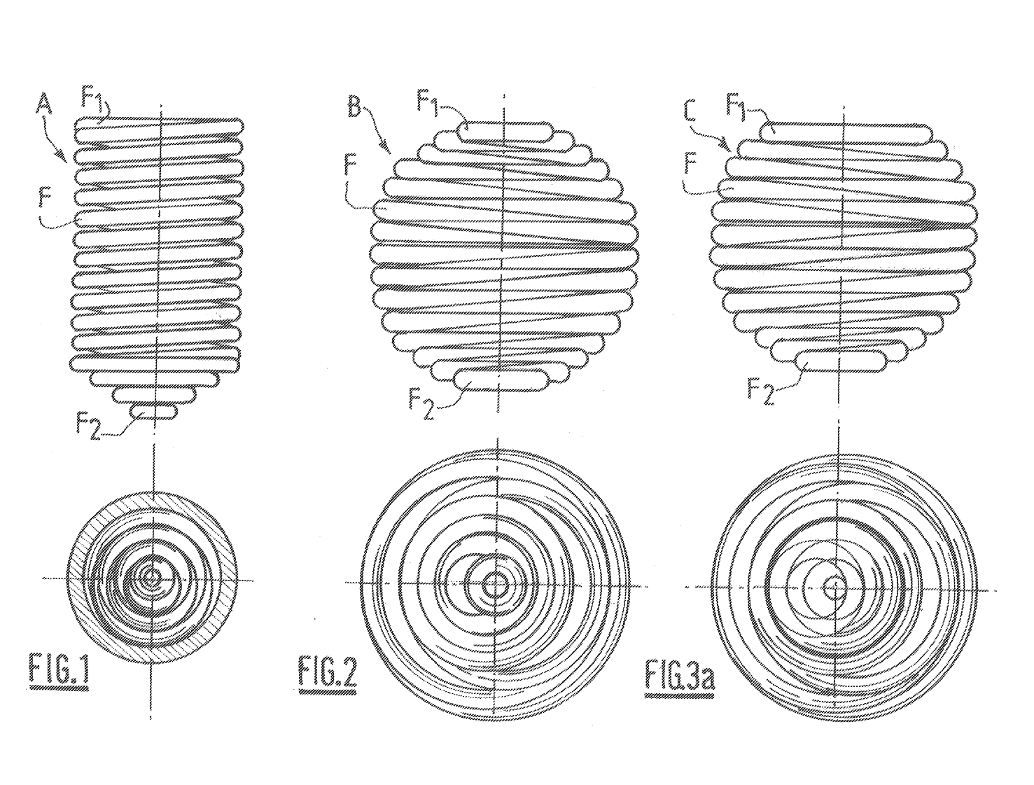

The side view in FIGS. 1 to 4 shows each element in its entirety and, more specifically, the cylindrical or spherical geometry. The plan view gives access to the open and closed ends of the elements and to the nonlimiting variations.

FIG. 1 depicts an element A: this element is cylindrical, with non-contiguous turns of pitch PA and has one open end F1 and one closed end F2 obtained by conical narrowing, of the contiguous-turns type, of the main geometry.

FIG. 2 depicts an element B: this element is spherical, with contiguous turns of pitch PB and has two closed ends F1 and F2.

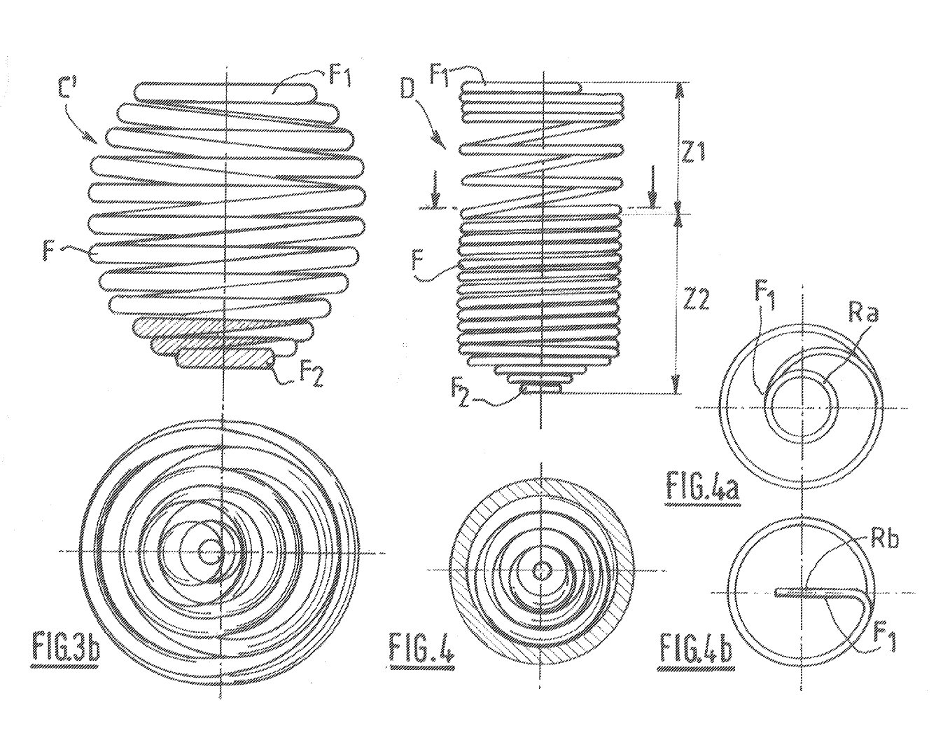

FIG. 3a depicts an element C: this element is spherical, with contiguous turns of pitch PC and has one open end F1 and one closed end F2.

FIG. 3b depicts an element C′: this element is also spherical, but with non-contiguous turns of pitch PC'. It too has one open end F1 and one closed end F2.

FIG. 4 depicts an element D: this element is cylindrical, with non-contiguous turns of pitch PD1 in the fluid inlet zone Z1 and PD2 in the fluid filtration zone Z2. The element has one open end F1 associated with Z1 and one closed end F2 associated with Z2 and obtained by conical narrowing, with contiguous turns, of the main geometry. In the variations depicted in FIGS. 4a and 4b, the open end F1 contains a return Ra of the wire of cross section (s) in a concentric circle (FIG. 4a) or else a radial return Rb (FIG. 4b) the length of which is preferably comprised between ⅓ and ⅔ of the diameter of the cylinder. Version D corresponds to the optimum version adopted for performing the filtration tests the results of which are given in the examples.

It should be noted that these filtering elements may differ from one another (from one version to another or within one and the same category) through variations in one or more parameters:
total height of the element
surface area (S_{wire}) occupied by the wire and free surface area (S_{free}) of the element, within the previously-defined ratio S_{free}/S_{wire},
open or closed configuration of the ends and associated geometries;
inside diameter Di of the element;
contiguous or non-contiguous configurations of the turns (pitch) and how they are distributed over the entire height of the element;
material of the wire and geometry, dimensions of its cross section (s);
density of the element.

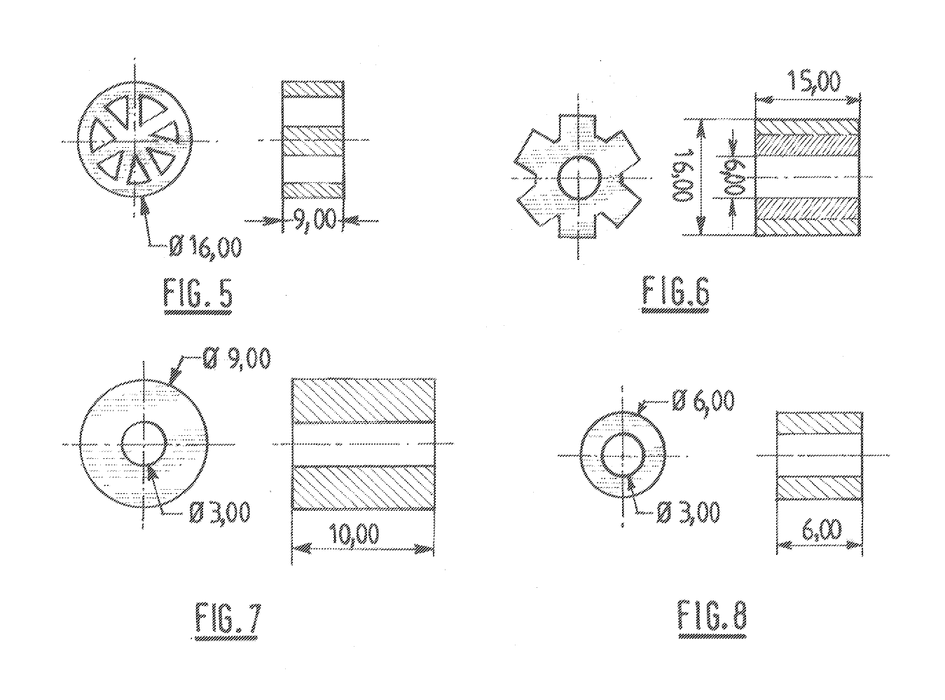

FIGS. 5 to 15 show the various geometries of the inert bodies tested in the example by comparison with the filtering element of optimum geometry according to version D. These inert bodies are spherical or cylindrical, solid or penetrated by channels of circular, oval or triangular cross section, with or without roughnesses on the surface.

### DETAILED DESCRIPTION OF THE INVENTION

According to the invention, the filtering elements may be used in any industrial process that entails purifying a fluid charge that contains particles.

In the examples depicted in FIGS. 1 to 4, the hollow elements are obtained by winding a single wire F of cross section (s) into turns. Each element has two ends F1, F2, situated opposite one another along the axis of winding of the turns.

The example depicted in FIG. 3b is a variant, with non-contiguous turns, of the spherical geometry depicted in FIG. 3a, because the geometry of the element is no longer a perfect sphere but a sphere which is elongated in the direction of the axis of winding of the turns.

Thus, the filtering elements can be inserted, by way of simple filter bed, in a physical treatment reactor that has the function of purifying, by filtering, a particle-laden fluid. As explained before, the filtering elements can be used alone or combined with other elements of different shapes and/or dimensions and/or functions. In a chemical or para-chemical manufacturing unit, the purified fluid may then be loaded into a monophase or polyphase operating reactor in which the desired chemical conversion will take place.

In a fixed bed catalytic reactor, the filtering elements can be inserted, alone or combined with others, in place of the inert beads and/or on a distribution plate situated upstream of the catalytic bed and on which chimneys can rest.

As described before, the filtering elements may, depending on the applications, differ from one another through variations in one or more parameters. Table 1 collates the preferred parameters of the cylindrical and spherical geometries of these filtering elements for an application in a fixed bed catalytic reactor used, for example, in the field of refinery for hydrotreatment reactions. In this application, tests of loading the filtering elements in bulk from the top of the reactor show that the cylindrical geometry is the geometry best suited to obtaining an effective filter bed. This is because however they are positioned after charging, the cylindrical filtering elements always have openings, thus encouraging good circulation of the fluid and therefore filtration thereof. Once blocked by the buildup of particles, the filtering elements continue to be active, providing the homogeneous dispersion of the purified fluid, a role customarily performed by the inert beads. Finally, when the gaps between the filtering elements have themselves become blocked, it is easy for the elements to be removed, cleaned or replaced, the cost of manufacture of which elements is low.

The filtering elements according to the invention as set out in Table 1 each have one closed end and one open end.

TABLE 1

| Element geometry | Cylinder | Sphere |
|---|---|---|
| Dimensions of the element | Height (H) ≦50 mm, | Maximum inside diameter |
| | preferably comprised | (Di) of the sphere ≦50 mm, |
| | between 10 and 35 mm with | preferably comprised |
| | an inside diameter from 10 | between 10 and 35 mm. |
| | to 20 mm. | |
| Open end | Simple opening equal to the | Circular opening of |
| | diameter of the cylinder or | diameter ≦ Di/2 |
| | opening terminating in a | |
| | return of the wire in a | |
| | concentric circle of inside | |
| | diameter ranging from 5 to | |
| | 10 mm, or | |
| | opening terminating in a | |
| | radial return of the wire the | |
| | length of which is comprised | |
| | between ⅓ and ⅔ of the | |
| | diameter of the cylinder. | |
| Configuration and | Non-contiguous with pitch | Non-contiguous turns of |
| distribution of the turns | ≦1 mm over the entire | pitch ≦1 mm, preferably |
| | height, preferably ≦0.5 mm, | comprised between 0.2 and |
| | more preferably still, | 0.8 mm. |
| | ≦0.2 mm, or | |
| | combination of non- | |
| | contiguous turns of pitch | |
| | ≦1 mm, of non-contiguous | |
| | turns of pitch ≦5 mm and of | |
| | 2 to 5 contiguous turns | |
| Closed end | Conical winding on | Closed end of the sphere |
| (geometry, height) | contiguous turns 2 mm to | |
| | 5 mm high. | |
| Ratio S_{free}/S_{wire} | 20% to 25% | 15% to 25% |
| Wire used to make | Wire of circular cross | Wire of circular cross |
| the element (cross | section 0.5 to 1 mm in | section 0.5 to 1 mm in |
| section, material, | diameter made of steel or | diameter made of steel or |
| diameter) | stainless steel and | stainless steel and |
| | preferably of Inox 321 or | preferably of Inox 321 or |
| | 304 | 304 |
| Weight of element | 0.5 to 1 g | 2 to 2.5 g |
| (in grams) | | |
| Density of element | 1.45 to 1.65 | 1.400 |

### EXAMPLES

The examples set out hereinafter are aimed at illustrating the advantages of the invention.

The Applicant Company has set itself the task of evaluating and comparing the filtering capability of the elements formed of a helical winding according to the invention.

The tests were performed on 13 references of comparative elements customarily used for filtration (cf. FIGS. 5 to 15) as compared against an element D according to the invention, formed of a hollow cylindrical helical winding closed at one end and open at the other (cf. FIG. 4—version D with a simple opening). With the exception of reference No 4, no other reference has any catalytic activity.

References 1 and 2 are solid spheres with a diameter of 12.7 mm (½″) and 3.175 mm (⅛″) respectively.

References 3 to 13 correspond to the elements depicted in FIGS. 5 to 15 respectively.

The filtering element according to the invention (element D) used in these tests is defined by the following parameters:
Total height of the element: 23 mm
22%≦S_{free}/S_{wire}≦23%
P1/P2≦15
Inside diameter Di of the element: 10 mm
Configuration of the element:

Cylinder 20 mm high consisting of one open end followed by 3 contiguous turns, themselves followed by a zone Z1 made up of 2 non-contiguous turns with a constant pitch PD1 of 3 mm, said zone Z1 being followed by a zone Z2 made up of non-contiguous turns with a constant pitch PD2 of 1 mm over a height of 8 mm, said zone Z2 being followed by a conical closed end with contiguous turns over a height of 3 mm.
Wire of Inox 321 of circular cross section 0.8 mm in diameter.

The tests involved evaluating the retention power of a filter bed consisting of a certain reference of filtering elements. The elements of one and the same reference were thus loaded in loose to form a filter bed on a column 60 cm high and 10 cm in diameter.

In the first series of tests, each of the beds consisting of one of the 14 references was weighed empty then subjected, for 2 hours, to a liquid flow rate (120 l/h of water) laden with clogging particles (2 kg of solid particles with a particle size varying from 10 μm to 400 μm) and to a gas flow rate (2.5 m³/h of air). At the end of each test, the particle-laden elements that constituted the filter beds were dried in an oven at 120° C. for 24 hours and then weighed. Table 2 collates the results of this first series and reveals the overall filtration capability of a filter bed consisting of one same category of elements.

These tests demonstrate the very low filtration capability of the majority of the elements tested: 86% of the filter beds retain under 3% of particles. The two best-performing filter beds respectively retain a little over 7% of particles in the case of the filter bed made up of the elements bearing the reference No. 12 and a little over 5% in the case of the filter bed consisting of the elements bearing the reference No. 14 (filtering element D according to the invention).

Studying with the naked eye the elements D according to the invention shows that the particles accumulate on the inside of the elements until these elements become saturated.

In the second series of tests, the two filter beds consisting of the best-performing filtration elements (references 12 and 14) determined in series 1 of tests were subjected continuously to 3 successive passes, each lasting 2 hours, of the liquid laden with clogging particles at a gas flow rate (namely 3 times 120 l/h of water laden with 2 kg of solid particles with a particle size varying from 10 to 400 μm under an air flow rate of 2.5 m³/h). Between each pass, the elements under test were neither cleaned nor replaced. The particle-laden elements that made up the filter beds were weighed after drying in an oven (120° C. for 24 hours). These cumulative tests show that the hollow elements formed of a helical winding according to the invention have almost twice the filtration capability of the elements No. 12. The elements according to the invention therefore perform an “active” filtration resulting from their own inherent geometry, unlike the elements No. 12 which become saturated more quickly.

The results of these cumulative tests show that, thanks to their suitable geometry, the elements according to the invention actively filter the particle-laden liquid, these particles accumulating within the elements until they entirely fill them.

Elements No. 12 perform only “passive retention” of the particles which accumulate in the gaps left free between the elements. The roughnesses on the surface of the elements No. 12 are able to capture particles, but rapidly become saturated and do not allow the capture of a significant volume of particles.

Unlike the hollow elements formed of a helical winding, the other elements lack effectiveness and cannot therefore be qualified as filtering within the meaning of the invention.

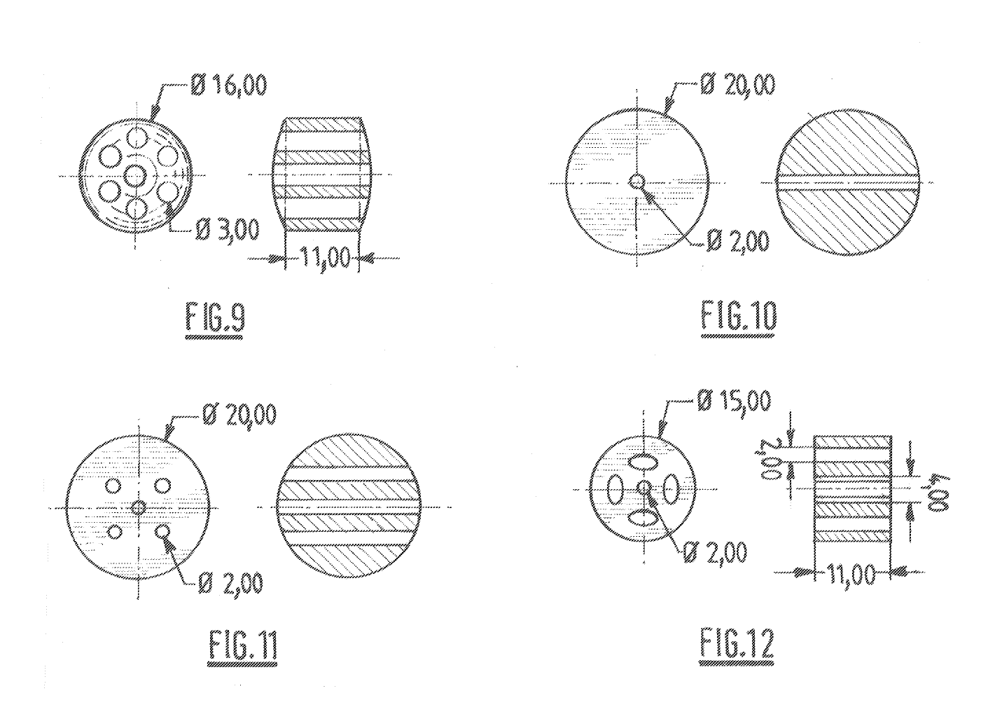

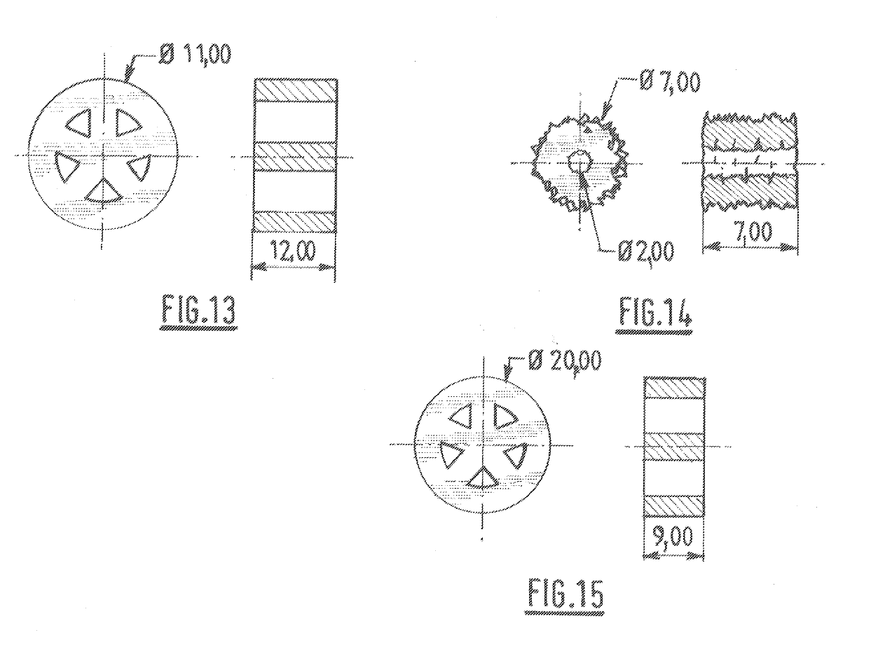

TABLE 2

| | | | - Series 1 - | | - Series 2 - | |
|---|---|---|---|---|---|---|
| | | | (2 h) | | Cumulative tests (3 × 2 h) | |
| | | | | % retained by the column | without cleaning of the column | |
| | | | Mean total mass | with respect to the | Mean total mass | |
| Reference No. | | Dimensions | retained by the | quantity (by weight) of | retained by the | % retained |
| (associated figure) | Geometry | (mm) | column (grams) | particles introduced | column (grams) | by the column |
| 1 | Sphere | 12.7 (½″) | 6 | 0.3 | | |
| | (beads) | | | | | |
| 2 | Sphere | 3.175 (⅛″) | 37 | 1.9 | | |
| | (beads) | | | | | |
| 3 | 7-spoke | 16 × 9 | 44 | 2.21 | | |
| (FIG. 5) | wheel | | | | | |
| 4 | Star-like | 15 × 16 | 14 | 0.70 | | |
| (FIG. 6) | cylinder | | | | | |
| 5 | Hollow | 9 × 10 | 41 | 2.1 | | |
| (FIG. 7) | cylinder | | | | | |
| 6 | Hollow | 6 × 6 | 30 | 1.8 | | |
| (FIG. 8) | cylinder | | | | | |
| 7 | Wheel pierced | 16 × 11 | 40 | 2.0 | | |
| (FIG. 9) | with 7 holes | | | | | |
| 8 | Macroporous | 20 | 8 | 0.4 | | |
| (FIG. 10) | sphere 1 hole | | | | | |
| 9 | Macroporous | 20 | 8 | 0.4 | | |
| (FIG. 11) | sphere 5 holes | | | | | |
| 10 | Pierced 4- | 15 × 11 | 48 | 2 | | |
| (FIG. 12) | spoke wheel | | | | | |
| | (5 holes) | | | | | |
| 11 | “Pentaring” | 11 × 12 | 48 | 2.4 | | |
| (FIG. 13) | | | | | | |
| 12 | Granular | 7 × 7 | 145 | 7.2 | 98 | 4.9 |
| (FIG. 14) | hollow | (D_{hollow} = 2) | | | | |
| | cylinder | | | | | |
| 13 | “Pentaring” | 20 × 9 | 35 | 1.7 | | |
| (FIG. 15) | | | | | | |
| 14 | Cylindrical | Inside | 105 | 5.25 | 160 | 8.1 |
| (FIG. 4) | element D | diameter 10 | | | | |
| | with helical | length 10 | | | | |
| | winding | | | | | |

1.-15. (canceled)

16. The use in a fixed bed catalytic reactor for filtering one or more particle-laden fluid(s) of at least one hollow element obtained by the winding into contiguous and/or non-contiguous turns of a wire of cross section(s), said hollow element comprising at least one closed end and having a ratio of free surface area (S_{free}) to surface area (S_{wire}) occupied by the wire that is comprised between 2 and 50%, in which use said at least one hollow element is positioned upstream of the fixed catalytic bed of the reactor in the form of a filter bed comprising at least one layer of hollow elements arranged loose in bulk.

17. The use for filtering one or more particle-laden fluid(s) of at least one hollow element as claimed in claim 16, characterized in that the ratio S_{free}/S_{wire} is comprised between 5 and 30%, preferably between 15 and 25%.

18. The use for filtering one or more particle-laden fluid(s) of at least one hollow element as claimed in claim 16, characterized in that said hollow element comprises one open end and one closed end.

19. The use for filtering one or more particle-laden fluid(s) of at least one hollow element as claimed in claim 16, characterized in that the hollow element is in the shape of a cylinder or of a sphere.

20. The use for filtering one or more particle-laden fluid(s) of at least one hollow element as claimed in claim 16, characterized in that the closed end is obtained by a conical narrowing of the wire of cross section (s) with contiguous turns.

21. The use for filtering one or more particle-laden fluid(s) of at least one hollow element as claimed in claim 16, characterized in that the closed end is flat.

22. The use for filtering one or more particle-laden fluid(s) of at least one hollow element as claimed in claim 16, characterized in that the hollow element is made of a metallic material, preferably steel or stainless steel.

23. The use for filtering one or more particle-laden fluid(s) of at least one hollow element as claimed in claim 16, characterized in that the hollow element comprises an open end followed by a fluid inlet zone Z1 consisting of non-contiguous turns of pitch P1, followed by a filtration zone Z2 consisting of non-contiguous turns of pitch P2<P1, and which is extended by a closed end.

24. The use for filtering one or more particle-laden fluid(s) of at least one hollow element as claimed in claim 23, characterized in that the pitches P1 and P2 of the non-contiguous turns are such that P1/P2≦50, preferably P1/P2≦15.

25. The use for filtering one or more particle-laden fluid(s) of at least one hollow element as claimed in claim 16, characterized in that the particle size is comprised between 1 μm and 20 mm.

26. The use for filtering one or more particle-laden fluid(s) of at least one hollow element as claimed in claim 16, characterized in that the hollow elements of one and the same layer of the filter bed are identical to one another.

27. The use for filtering one or more particle-laden fluid(s) of at least one hollow element as claimed in claim 16, characterized in that filtration is performed using a filter bed comprising several layers of hollow elements organized in a gradient graded on hollow element size.

28. The use for filtering one or more particle-laden fluid(s) of at least one hollow element as claimed in claim 16, characterized in that the hollow elements of one and the same layer of the filter bed are used alone or in combination with other elements, preferably particles of catalyst.

29. The use for filtering one or more particle-laden fluid(s) of at least one hollow element as claimed in claim 16.
